(19) United States
(12) Patent Application Publication
(10) Pub. No.: US 2026/0251941 A1
(43) Pub. Date: Aug. 27, 2026

(54) DISPLAY SUBSTRATE, DISPLAY PANEL AND DISPLAY APPARATUS

(71) Applicants: Wuhan BOE Optoelectronics Technology Co.,Ltd., Wuhan, Hubei (CN); BOE Technology Group Co., Ltd., Beijing (CN)

(72) Inventors: Lu SHEN, Beijing (CN); Xin LIU, Beijing (CN); Yujie GAO, Beijing (CN); Peng JIANG, Beijing (CN); Chao WANG, Beijing (CN); Jun DING, Beijing (CN); Zengjie KONG, Beijing (CN); Yazheng QIAO, Beijing (CN); Ming WANG, Beijing (CN); Xinxin ZHAO, Beijing (CN)

(21) Appl. No.: 18/881,960

(22) PCT Filed: Apr. 17, 2024
(86) PCT No.: PCT/CN2024/088360

§ 371 Date: Jan. 7, 2025

(30) Foreign Application Priority Data
May 25, 2023 (CN) 202310602648.5

(51) Int. Cl. G02F 1/1362

(52) U.S. Cl. CPC G02F 1/136286

(57) ABSTRACT

A display substrate, a display panel and a display apparatus are provided. The display substrate has a display area and a non-display area at the periphery of the display area. The display substrate includes: multiple fanout wiring groups in the non-display area and a common electrode between adjacent fanout wiring groups in the non-display area. At least one fanout wiring group includes multiple fanout wirings. The common electrode includes a boundary wiring and a common wiring group in a region surrounded by the boundary wiring. The common wiring group includes: multiple first common wirings and multiple second common wirings. The first common wirings and the second common wirings intersect to form a grid structure. The extension direction of at least one first common wiring is the same as the extension direction of at least one fanout wiring.

### CROSS-REFERENCE TO RELATED APPLICATIONS

This application is a national phase entry under 35 U.S.C. § 371 of International Application No. PCT/CN2024/088360, filed on Apr. 17, 2024, which claims priority to Chinese Patent Application No. 202310602648.5, filed with the China National Intellectual Property Administration on May 25, 2023 and entitled “Display Substrate, Display Panel and Display Apparatus”, the entire contents of which are incorporated herein by reference.

### TECHNICAL FIELD

The present disclosure relates to the field of semiconductor technology, and in particular to a display substrate, a display panel, and a display apparatus.

### BACKGROUND

Display apparatus have been applied to all aspects of our lives. Most of the display panels currently on the market are backlight liquid crystal displays. The backlight liquid crystal display includes a liquid crystal display panel and a backlight module. The working principle of the liquid crystal display panel is to place liquid crystal molecules between two parallel substrates (array substrate and color filter substrate), control the liquid crystal molecules to change direction by powering on or off, and refract light from the backlight module to generate a picture. On each of the color film substrate and the array substrate of the liquid crystal display, there is a layer of thin film material (liquid crystal orientation layer), called orientation film, which is usually made of polyimide material. The main function of the orientation film is to control the orientation of liquid crystal molecules, ensuring that the liquid crystal molecules can be arranged in the correct direction and form a certain pre-tilt angle.

### SUMMARY

The present disclosure provides a display substrate, a display panel and a display apparatus. The display substrate is provided with a display area and a non-display area located at a periphery of the display area.

The display substrate includes a plurality of fanout wiring groups in the non-display area. At least one of the plurality of fanout wiring groups includes: a plurality of fanout wirings.

The display substrate includes a common electrode between adjacent fanout wiring groups in the non-display area. The common electrode includes: a boundary wiring, and a common wiring group in a region surrounded by the boundary wiring. The common wiring group includes: a plurality of first common wirings and a plurality of second common wirings.

The plurality of first common wirings and the plurality of second common wirings intersect to form a grid structure.

An extension direction of at least one of the first common wirings is the same as an extension direction of at least one of the fanout wirings.

In some embodiments, the plurality of first common wirings include: a first sub-common wiring group and a second sub-common wiring group sequentially distributed along a first direction. The first sub-common wiring group includes: a plurality of first sub-common wirings extending along the same direction. The second sub-common wiring group includes: a plurality of second sub-common wirings extending along the same direction.

The extension direction of the first sub-common wiring is the same as the extension direction of the adjacent fanout wiring. The extension direction of the second sub-common wiring is the same as the extension direction of the adjacent fanout wiring.

In some embodiments, the fanout wiring group includes: a first sub-fanout wiring group and a second sub-fanout wiring group sequentially distributed along the first direction. The first sub-fanout wiring group includes: a plurality of first sub-fanout wirings extending in the same direction. The second sub-fanout wiring group includes: a plurality of second sub-fanout wirings extending in the same direction. The extension direction of the second sub-fanout wiring is different from the extension direction of the first sub-fanout wiring.

The first sub-common wiring group is adjacent to the second sub-fanout wiring group in one of the fanout wiring groups. An extension direction of the first sub-common wiring is the same as an extension direction of the adjacent second sub-fanout wiring group. The second sub-common wiring group is adjacent to the first sub-fanout wiring group in another one of the fanout wiring groups. The extension direction of the second sub-common wiring is the same as an extension direction of the adjacent first sub-fanout wiring.

In some embodiments, the second common wiring extends along a direction perpendicular to the first direction.

In some embodiments, the second common wiring includes: a plurality of third sub-common wirings extending in the same direction, and a plurality of fourth sub-common wirings extending in the same direction.

The extension direction of the third sub-common wiring is perpendicular to the extension direction of the first sub-common wiring. The third sub-common wirings and the first sub-common wirings intersect to form a grid structure.

An extension direction of the fourth sub-common wiring is perpendicular to an extension direction of the second sub-common wiring. The fourth sub-common wirings and the second sub-common wirings intersect to form a grid structure.

In some embodiments, a first gap is formed between one first sub-common wiring and another first sub-common wiring adjacent to a side of the one first sub-common wiring. A second gap is formed between the one first sub-common wiring and another first sub-common wiring adjacent to the other side of the one first sub-common wiring. The third sub-common wirings in the first gap and the second gap are staggered.

A third gap is formed between one second sub-common wiring and another second sub-common wiring adjacent to a side of the one second sub-common wiring. A fourth gap is formed between the one second sub-common wiring and another second sub-common wiring adjacent to the other side of the one second sub-common wiring. The fourth sub-common wirings in the third gap and the fourth gap are staggered.

In some embodiments, the non-display area includes: a third common wiring located on a side of the common electrode facing the display area.

The display substrate further includes: a connecting electrode connecting the third common wiring and the common electrode. The connecting electrode includes: a plurality of first connecting wirings and a plurality of second connecting wirings. The first connecting wirings and the second connecting wirings intersect to form a grid structure.

In some embodiments, the first connecting wiring includes: a first sub-connecting wiring, and a second sub-connecting wiring.

An extension direction of the first sub-connecting wiring is the same as an extension direction of the first sub-common wiring. An extension direction of the second sub-connecting wiring is the same as an extension direction of the second sub-common wiring.

In some embodiments, the first connecting wiring extends along the first direction.

In some embodiments, the second connecting wiring extends along a direction perpendicular to the first direction.

In some embodiments, the common electrode includes: a plurality of first grids, a plurality of second grids, and a plurality of third grids. The area of the first grid is greater than that of the second grid, and the area of the second grid is greater than that of the third grid.

In some embodiments, the common electrode includes: a first common electrode region, a second common electrode region, and a third common electrode region sequentially distributed along the first direction.

The second grids are distributed in the first common electrode region and the third common electrode region.

The first grid and the third grid are distributed in the second common electrode region. In a direction perpendicular to the first direction, the first grids and the third grids are alternately distributed.

In some embodiments, the area of the grid in the connecting electrode is substantially equal to the area of the second grid in the common electrode.

In some embodiments, the area of the grid in the connecting electrode is larger than the area of the grid in the common electrode.

In some embodiments, an aperture ratio of the connecting electrode is greater than 50%. An aperture ratio of the common electrode is greater than 50%.

In some embodiments, the non-display area includes: a third common wiring located on a side of the common electrode facing the display area. The common electrode is directly electrically connected to the third common wiring.

In some embodiments, at least one dummy wiring is provided between the common electrode and the fanout wiring group. An extension direction of the dummy wiring is the same as an extension direction of the adjacent fanout wiring.

In some embodiments, the plurality of dummy wirings are evenly distributed between the common electrode and the fanout wiring group.

In some embodiments, the display substrate further includes, in the non-display area: a plurality of first transfer structures, and fanout region transfer wirings corresponding one-to-one to the fanout wirings. The fanout region transfer wirings are electrically connected to the fanout wirings through the first transfer structures.

In some embodiments, the display substrate further includes: a second switching structure in the non-display area. The third common wiring is electrically connected to a fourth common wiring in the display area through the second switching structure.

Embodiments of the present disclosure further provide a display panel, which includes the display substrate provided in the embodiments of the present disclosure.

Embodiments of the present disclosure further provide a display apparatus, which includes the display panel provided by the embodiments of the present disclosure.

### BRIEF DESCRIPTION OF DRAWINGS

FIG. 1 is a schematic top view of a display substrate provided in an embodiment of the present disclosure.

FIG. 2 is a first enlarged schematic diagram of the dotted line frame S in FIG. 1.

FIG. 3 is a second enlarged schematic diagram of the dotted line frame S in FIG. 1.

FIG. 4 is a third enlarged schematic diagram of the dotted line frame S in FIG. 1.

FIG. 5 is a first partial enlarged schematic diagram of a common electrode.

FIG. 6 is a second partial enlarged schematic diagram of a common electrode.

FIG. 7 is a third partial enlarged schematic diagram of a common electrode.

FIG. 8 is a fourth enlarged schematic diagram of the dotted line frame S in FIG. 1.

FIG. 9 is a fifth enlarged schematic diagram of the dotted line frame S in FIG. 1.

FIG. 10 is a sixth enlarged schematic diagram of the dashed line frame S in FIG. 1.

FIG. 11 is a seventh enlarged schematic diagram of the dotted line frame S in FIG. 1.

### DETAILED DESCRIPTION

In order to make the purpose, technical solution and advantages of the embodiments of the present disclosure more clear, the technical solution of the embodiments of the present disclosure will be clearly and completely described below in conjunction with the drawings of the embodiments of the present disclosure. Obviously, the described embodiments are only part of the embodiments of the present disclosure, rather than all the embodiments. Based on the described embodiments of the present disclosure, all other embodiments obtained by those of ordinary skill in the art without creative work are within the scope of protection of the present disclosure.

Unless otherwise defined, technical or scientific terms used in the present disclosure should have the common meanings understood by a person having ordinary skills in the field to which the present disclosure belongs. The terms “first”, “second” and the like used in the present disclosure do not indicate any order, quantity or importance, but are only used to distinguish different components. Words such as “include” or “comprise” mean that the elements or objects preceding the word include the elements or objects listed after the word and their equivalents, but do not exclude other elements or objects. The words “connect” or “connected” and the like are not limited to physical or mechanical connections, but may include electrical connections, whether direct or indirect. “Up”, “down”, “left”, “right”, etc. are only used to indicate relative position relationships. When the absolute position of the described object changes, the relative position relationship may also change accordingly.

As used herein, “about” or “substantially equal” is inclusive of the stated value and means within an acceptable range of deviation for the value as determined by one of ordinary skill in the art taking into account the measurements in question and errors associated with the measurement of the value (i.e., the limitations of the measurement system). For example, “substantially equal” may mean within one or more standard deviations, or within ±30%, 20%, 10%, 5% relative to the stated value.

In the drawings, the thickness of layers, films, panels, regions, etc., are exaggerated for clarity. Exemplary embodiments are described herein with reference to cross section diagrams that are schematic diagrams of idealized embodiments. As such, deviations from the shapes of the diagrams as a result, for example, of manufacturing techniques and/or tolerances, are to be expected. Thus, embodiments described herein should not be construed as limited to the particular shapes of regions as illustrated herein but include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shapes of the regions and are not intended to limit the scope of the present claims.

In order to keep the following description of the embodiments of the present disclosure clear and concise, the present disclosure omits detailed descriptions of well-known functions and well-known components.

Under normal circumstances, when no signal is applied, the LCD screen is completely dark and light cannot pass through the LCD screen. If there is light leakage in this dark state, it will seriously reduce the visual effect of the entire display screen, making consumers not have a good visual experience. One of the reasons for light leakage at corners of the LCD screen is that the orientation film coated on the non-display area and the display area of the array substrate is unevenly distributed. During the formation of the orientation film, the orientation liquid flows along the line region (Fanout region) of the peripheral circuit, and the diffusion in an adjacent region where the common electrode (Vcom) is introduced is poor, resulting in the aggregation of the orientation liquid. Defects such as yellowing corners and peripheral Mura occur in the aggregation region of the orientation liquid, which seriously affects the image quality. In conventional technology, the Vcom region adopts square grid wirings, the wiring direction is vertical/horizontal, the wiring density is high, and the aperture ratio is low. The Fanout region is located on both sides of the Vcom region. The wiring direction in the Fanout region has a certain angle. There is a substrate blank region between the Vcom region and the Fanout region, which has a relatively low height and forms a channel. In an actual production process, when the orientation liquid coating process is carried out, the orientation liquid flows faster along the substrate blank region between the Vcom region and Fanout region, and flows slower along the grid wiring direction of the Vcom region. It is easy for the orientation liquid to aggregate in the Vcom region, resulting in yellowing corners and peripheral Mura, which seriously affects the image quality.

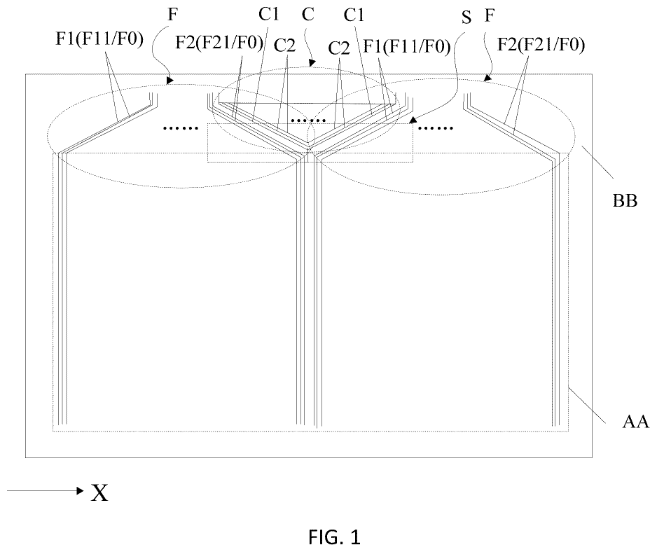

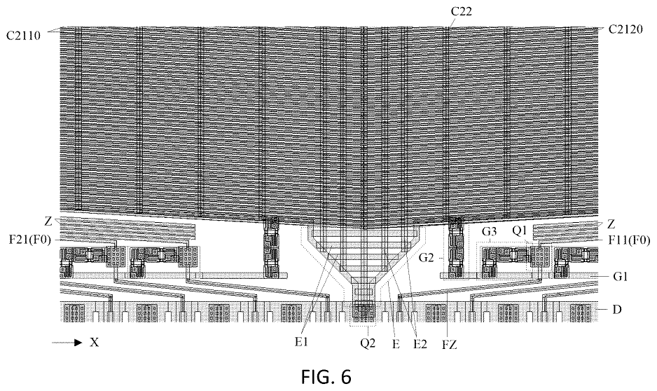

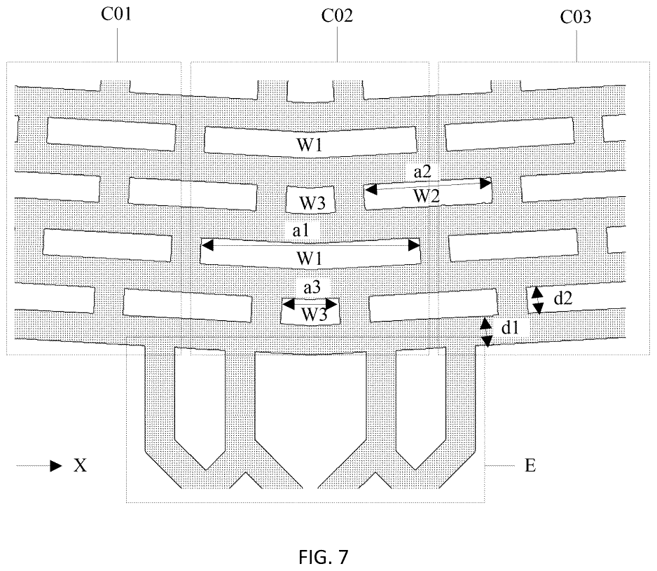

In view of this, referring to FIGS. 1 to 7, FIGS. 2 to 4 are enlarged schematic diagrams of the dotted line frame S in FIG. 1, FIG. 5 is a first partial enlarged schematic diagram of a common electrode, FIG. 6 is a second partial enlarged schematic diagram of a common electrode, and FIG. 7 is a third partial enlarged schematic diagram of a common electrode. In embodiments of the present disclosure, a display substrate is provided, having a display area AA and a non-display area BB located at a periphery of the display area AA.

The display substrate includes a plurality of fanout wiring groups F in the non-display area BB. At least one of the plurality of fanout wiring groups F includes a plurality of fanout wirings F0.

The display substrate further includes a common electrode C between adjacent fanout wiring groups F in the non-display area BB. The common electrode C includes: a boundary wiring C1, and a common wiring group C2 in the region surrounded by the boundary wiring C1. The common wiring group C2 includes: a plurality of first common wirings C21, and a plurality of second common wirings C22. The plurality of first common wirings C21 and the plurality of second common wirings C22 intersect to form a grid structure.

The extension direction of at least one first common wiring C21 is the same as the extension direction of at least one fanout wiring F0.

In embodiments of the present disclosure, the common electrode C includes: a boundary wiring C1, and a common wiring group C2 located in the region surrounded by the boundary wiring C1. The common wiring group C2 includes: a plurality of first common wirings C21 and a plurality of second common wirings C22. The extension direction of at least one first common wiring C21 is the same as the extension direction of at least one fanout wiring F0. By changing the wiring structure of the common electrode C, the flow direction of the orientation liquid in the orientation liquid coating process can be changed while reducing the resistance, thereby improving problems such as yellowing corners and peripheral Mura. Further, it can effectively improve the edge margin EM of the orientation film, thus reducing the thickness of the liquid crystal box and reducing costs. Furthermore, the disclosed embodiments effectively improve image quality, increase yield, and reduce costs without adding additional mask steps and process steps.

It should be noted that FIG. 1 is a schematic illustration of an example in which a display substrate includes two fanout wiring groups F and a common electrode C. In implementations, the display substrate may also include a larger number of fanout wiring groups F and a larger number of common electrodes C, and the embodiments of the present disclosure are not limited thereto.

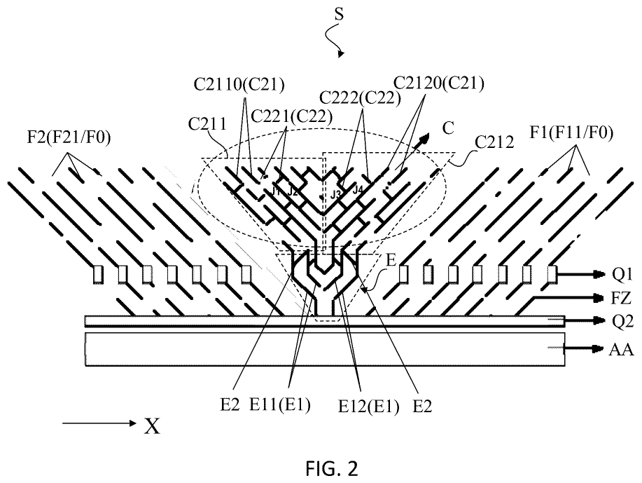

In some embodiments, referring to FIGS. 2 to 7, the plurality of first common wirings C21 include: a first sub-common wiring group C211 and a second sub-common wiring group C212 sequentially distributed along a first direction X. The first sub-common wiring group C211 includes: a plurality of first sub-common wirings C2110 extending in the same direction. The second sub-common wiring group C212 includes: a plurality of second sub-common wirings C2120 extending in the same direction.

The extension direction of the first sub-common wiring C2110 is the same as the extension direction of the adjacent fanout wiring F0. The extension direction of the second sub-common wiring C2120 is the same as the extension direction of the adjacent fanout wiring F0. For example, as shown in FIG. 2, the first sub-common wiring C2110 is adjacent to the fanout wiring F0 on the left, and the extension direction of the first sub-common wiring C2110 is the same as the extension direction of the adjacent fanout wiring F0 on the left side. The second sub-common wiring C2120 is adjacent to the fanout wiring F0 on the right side, and the extension direction of the second sub-common wiring C2120 is the same as the extension direction of the adjacent fanout wiring F0 on the right side.

In some embodiments, referring to FIGS. 1 to 7, the fanout wiring group F includes: a first sub-fanout wiring group F1 and a second sub-fanout wiring group F2 distributed in sequence along a first direction X. The first sub-fanout wiring group F1 includes: a plurality of first sub-fanout wirings F11 extending in the same direction. The second sub-fanout wiring group F2 includes: a plurality of second sub-fanout wirings F21 extending in the same direction. The extension direction of the second sub-fanout wiring F21 is different from the extension direction of the first sub-fanout wiring F11.

The first sub-common wiring group C211 is adjacent to the second sub-fanout wiring group F2 in a fanout wiring group F, and the extension direction of the first sub-common wiring C2110 is the same as the extension direction of the adjacent second sub-fanout wiring F21. For example, as shown in FIG. 2, the first sub-common wiring group C211 is adjacent to the second sub-fanout wiring group F2 in the fanout wiring group F on the left. The extension direction of the first sub-common wiring C2110 is the same as the extension direction of the adjacent second sub-fanout wiring F21 on the left. The second sub-common wiring group C212 is adjacent to the first sub-fanout wiring group F1 in another fanout wiring group F. The extension direction of the second sub-common wiring C2120 is the same as the extension direction of the adjacent first sub-fanout wiring F11. For example, as shown in FIG. 2, the second sub-common wiring group C212 is adjacent to the first sub-fanout wiring group F1 in the fanout wiring group F on the right, then the extension direction of the second sub-common wiring C2120 is the same as the extension direction of the adjacent first sub-fanout wiring F11 on the right. In examples, unlike the vertical and horizontal grid design, an inclined Vcom wiring is adopted, which makes it easier for the orientation liquid to flow along the wiring, thereby improving problems such as yellowing corners and peripheral Mura.

In some embodiments, referring to FIGS. 2-5, the second common wiring C22 includes: a plurality of third sub-common wirings C221 extending in the same direction, and a plurality of fourth sub-common wirings C222 extending in the same direction. The extension direction of the third sub-common wiring C221 is perpendicular to the extension direction of the first sub-common wiring C2110. The third sub-common wirings C221 and the first sub-common wirings C2110 intersect to form a grid structure. The extension direction of the fourth sub-common wiring C222 is perpendicular to the extension direction of the second sub-common wiring C2120. The fourth sub-common wirings C222 and the second sub-common wirings C2120 intersect to form a grid structure. As compared with the second common wiring C22 extending in a direction perpendicular to the first direction X, in examples, the extension direction of the third sub-common wiring C221 is perpendicular to the extension direction of the first sub-common wiring C2110, and the extension direction of the fourth sub-common wiring C222 is perpendicular to the extension direction of the second sub-common wiring C2120, thus the orientation liquid can flow more easily along the wirings, and the drainage effect is better.

In some embodiments, as shown in FIG. 6, the second common wiring C22 extends in a direction perpendicular to the first direction X. In examples, the second common wiring C22 extends in a direction perpendicular to the first direction X. The wiring method is simple, which is conducive to simplifying the production of the display panel and is suitable for mass production.

In some embodiments, referring to FIGS. 2-5, there is a first gap J1 between the first sub-common wiring C2110 and the first sub-common wiring C2110 adjacent on one side, and there is a second gap J2 between the first sub-common wiring C2110 and the first sub-common wiring C2110 adjacent on the other side. The third sub-common wirings C221 in the first gap J1 and the second gap J2 are staggered. There is a third gap J3 between the second sub-common wiring C2120 and the second sub-common wiring C2120 adjacent on one side, and there is a fourth gap J4 between the second sub-common wiring C2120 and the second sub-common wiring C2120 adjacent on the other side. The fourth sub-common wirings C222 in the third gap J3 and the fourth gap J4 are staggered.

It should be noted that, in embodiments of the present disclosure, the staggered distribution of the third sub-common wirings C221 in the first gap J1 and the second gap J2 can be understood as one of the fourth sub-common wiring C221 is not on the extension line of the other fourth sub-common wiring C221. That is, the endpoints of the two fourth sub-common wirings do not overlap. Similarly, the staggered distribution of the fourth sub-common wiring C222 in the third gap J3 and the fourth gap J4 can be understood as one of the fourth sub-common wiring C222 is not on the extension line of the other fourth sub-common wiring C222. That is, the endpoints of the two fourth sub-common wirings do not overlap.

In some embodiments, referring to FIG. 6, the non-display area BB includes: a third common wiring D located on the side of the common electrode C facing the display area AA.

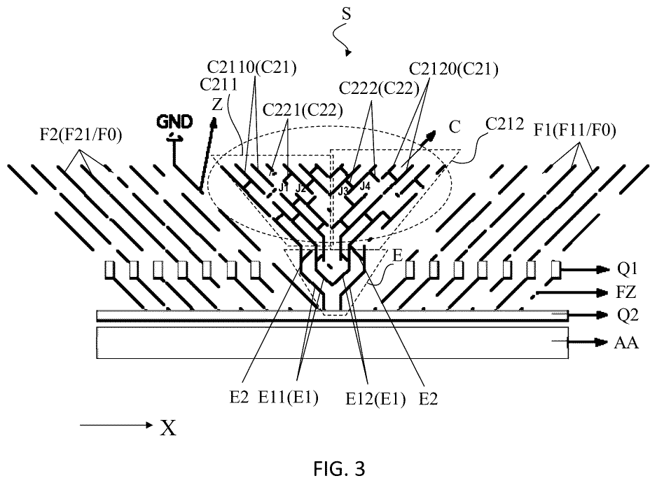

Referring to FIG. 2, FIG. 3, FIG. 5, and FIG. 6, the display substrate also includes: a connecting electrode E connecting the third common wiring D and the common electrode. The connecting electrode E includes: a plurality of first connecting wirings E1 and a plurality of second connecting wirings E2. The first connecting wirings E1 and the second connecting wirings E2 intersect to form a grid structure.

In some embodiments, referring to FIGS. 2 and 3, the first connecting wiring E1 includes: a first sub-connecting wiring E11 and a second sub-connecting wiring E12. The extension direction of the first sub-connecting wiring E11 is the same as the extension direction of the first sub-common wiring C2110. The extension direction of the second sub-connecting wiring E12 is the same as the extension direction of the second sub-common wiring C2120.

In some embodiments, referring to FIG. 2 and FIG. 3, at least one first sub-connecting wiring E11 and the first sub-common wiring C2110 form a one-piece connected structure. In some embodiments, the extension lines of the one-piece connected first sub-connecting wiring E11 and first sub-common wiring C2110 may not overlap. At least one second sub-connecting wiring E12 and the second sub-common wiring C2120 form a one-piece connected structure. In some embodiments, the extension lines of the one-piece connected second sub-connecting wiring E12 and the second sub-common wiring C2120 may not overlap.

It should be noted that one-piece connected can be understood as two being connected to each other, which is a pattern in which one end of one is connected to one end of the other in the same layer.

In some embodiments, referring to FIG. 5, the extension direction of the first sub-connecting wiring E11 may be different from the extension direction of the first sub-common wiring C2110. In some embodiments, the inclination angle of the first sub-connecting wiring E11 is greater than the inclination angle of the first sub-common wiring C2110. The extension direction of the second sub-connecting wiring E12 may be different from the extension direction of the second sub-common wiring C2120. In some embodiments, the inclination angle of the second sub-connecting wiring E12 is greater than the inclination angle of the second sub-common wiring C2120. In this way, a better drainage effect is achieved, and the problem of serious aggregation of the orientation liquid at the connecting electrode E is improved.

In some embodiments, referring to FIG. 6, the first connecting wiring E1 extends along the first direction X. In examples, the first connecting wiring E1 extends along the first direction X. While improving the aggregation of the orientation liquid at the connecting electrode E, the wiring method is simple, which is conducive to simplifying the production of the display panel.

In some embodiments, as shown in FIG. 6, the second connecting wiring E2 extends in a direction perpendicular to the first direction X. In examples, the second connecting wiring E2 extends in a direction perpendicular to the first direction X. While improving the aggregation of the orientation liquid at the connecting electrode E, the wiring method is simple, which is conducive to simplifying the production of the display panel.

In some embodiments, as shown in FIG. 6, at least one second connecting wiring E2 and the second common wiring C22 form a one-piece connected structure. In some embodiments, extension lines of the one-piece connected second connecting wiring E2 and second common wiring C22 coincide.

In some embodiments, referring to FIGS. 5-7, the common electrode C includes: a plurality of first grids W1, a plurality of second grids W2, and a plurality of third grids W3. The first grid W1, the second grid W2, and the third grid W3 are regions formed by the intersection of wirings in different directions, and may be hollow regions. The area of the first grid W1 is greater than the area of the second grid W2, and the area of the second grid W2 is greater than the area of the third grid W3. In embodiments of the present disclosure, the common electrode C includes a plurality of first grids W1, second grids W2, and third grids W3 of different sizes, so that the orientation liquid can flow evenly in the region where the common electrode C is located, avoiding problems such as yellowing corners and peripheral Mura caused by the aggregation of the orientation liquid.

In some embodiments, referring to FIG. 5 or FIG. 7, the common electrode C includes: a first common electrode region C01, a second common electrode region C02, and a third common electrode region C03 sequentially distributed along a first direction X. The second grids W2 are distributed in the first common electrode region C01 and the third common electrode region C03. The first grids W1 and the third grids W3 are distributed in the second common electrode region C02. In a direction perpendicular to the first direction, the first grids W1 and the third grids W3 are alternately distributed. In this way, the orientation liquid can flow evenly in the region where the common electrode C is located, avoiding the problems of yellowing corners and peripheral Mura caused by the aggregation of orientation liquid.

It should be noted that FIGS. 5 and 7 are schematic illustrations taking the first common electrode region C01, the second common electrode region C02, and the third common electrode region C03 as rectangles as an example. In implementations, the first common electrode region C01, the second common electrode region C02, and the third common electrode region C03 may also be irregular regions, and the embodiments of the present disclosure are not limited to this.

In some embodiments, referring to FIG. 7, the size a1 of the first grid W1 in the first direction ranges from 50 μm to 60 μm, for example, 50 μm, 52 μm, 54 μm, 55 μm, 56 μm, 57 μm, 58 μm, and 60 μm. The size a2 of the second grid W2 in the first direction X ranges from 25 μm to 35 μm, for example, 25 μm, 27 μm, 29 μm, 31μm, 32μm, 32.6 μm, 33 μm, 34 μm, and 35 μm. The size a3 of the third grid W3 in the first direction X ranges from 10 μm to 20 μm, for example, 10 μm, 12 μm, 14 μm, 14.9 mm, 15μm, 16 μm, 18 μm, and 20 μm.

In some embodiments, as shown in FIG. 7, within the common electrode C, the line width d1 may range from 5 μm to 8 μm, for example, 5 μm, 6 μm, 6.7 μm, 7 μm, and 8 μm. The line spacing d2 may range from 6 μm to 9 μm, for example, 6 μm, 7 μm, 7.2 μm, 8 μm, and 9 μm.

In some embodiments, the area of the grid in the connecting electrode E is substantially equal to the area of the second grid W2 in the common electrode C.

In some embodiments, referring to FIG. 5 or FIG. 7, the area of the grid in the connecting electrode E is greater than the area of the grid in the common electrode C. In this way, the orientation liquid can flow more easily at the connecting electrode E, thereby improving the problem of severe aggregation of the orientation liquid at the connecting electrode E.

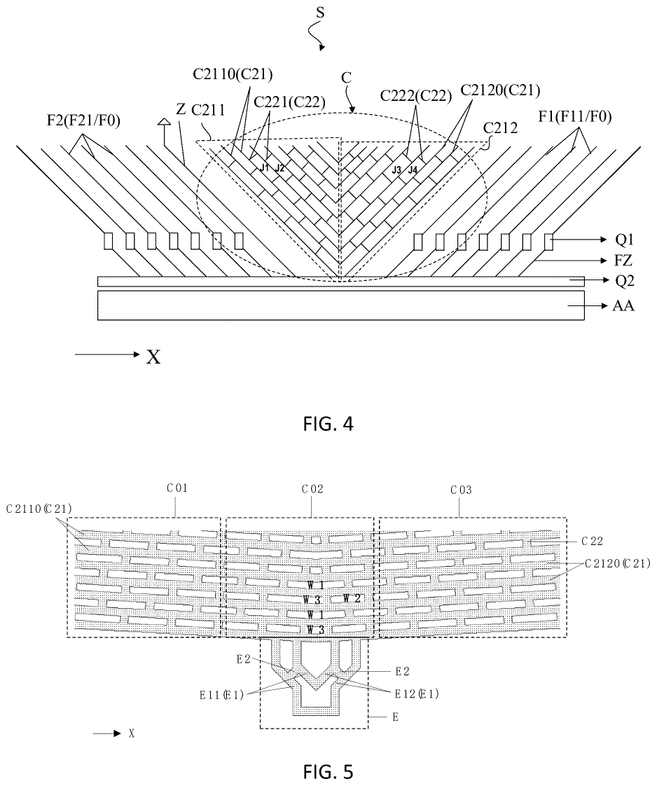

In some embodiments, referring to FIG. 6, the non-display area BB includes: a third common wiring D located on the side of the common electrode C facing the display area AA. Referring to FIG. 4, the common electrode C is directly electrically connected to the third common wiring D. That is, no connecting electrode E is provided between the common electrode C and the third common wiring D, and the overall shape of the common electrode C changes from the original irregular polygon to a triangle. In embodiments of the present disclosure, the common electrode C is directly electrically connected to the third common wiring D, which can increase the overall wiring area of the common electrode C and reduce the area of the channel formed by the blank region between the Fanout region and the Vcom region, so that the flow rates of the orientation liquid in the blank region and the wiring region are substantially equal, thereby improving the problem of aggregation of orientation liquid.

In some embodiments, the aperture ratio of the connecting electrode E is greater than 50%. The aperture ratio of the common electrode C is greater than 50%. In embodiments of the present disclosure, the aperture ratio of the connecting electrode E is greater than 50%, and the aperture ratio of the common electrode C is greater than 50%, which can increase the area of the grid, make the orientation liquid flow more easily, and improve the problem of aggregation of orientation liquid.

In some embodiments, referring to FIG. 3, FIG. 4 and FIG. 6, at least one dummy wiring Z is provided between the common electrode C and the fanout wiring group F. The extension direction of the dummy wiring Z is the same as the extension direction of the adjacent fanout wiring FO. In embodiments of the present disclosure, at least one dummy wiring Z is arranged between the common electrode C and the fanout wiring group F. That is, a floating (Dummy) region is arranged in a blank region between the Fanout region and the Vcom region. At least one dummy wiring Z is arranged in the Dummy region. The Dummy region is grounded and does not actually provide voltage to the display area, but only serves to guide the flow of the orientation liquid.

In some embodiments, the Dummy region includes one or several straight wirings with a certain inclination angle. The number of wirings in the Dummy region is determined by the size of the blank region between the Fanout region and the Vcom region. The wiring spacing in the Dummy region is equal to the wiring spacing in the Fanout region. The wiring width in the Dummy region can be equal to the wiring width in the Fanout region. The inclination angle of the wiring in the Dummy region is the same as the inclination angle of the wiring in the Fanout region. The wiring in the Dummy region is connected to the ground GND at the circuit signal input. The material of the dummy wiring Z in the Dummy region can be the same as that of the fanout wiring, and can be made of metal materials such as Cu or Al. The Dummy region is close to the Vcom region, guiding the flow of the orientation liquid in the Vcom region. The Dummy region and the Fanout region are manufactured in the same process without a new mask or adding any process steps.

In some embodiments, the plurality of dummy wirings Z are evenly distributed between the common electrode C and the fanout wiring group F. That is, the spacings between the plurality of dummy wirings Z are the same.

In some embodiments, referring to FIGS. 2-4 and 6, the display substrate further includes in the non-display area BB: a plurality of first transfer structures Q1, and fanout region transfer wirings FZ corresponding one-to-one to the fanout wirings F0. The fanout region transfer wirings FZ are electrically connected to the fanout wirings F0 through the first transfer structures Q1.

In some embodiments, referring to FIGS. 2-4 and 6, the display substrate further includes: a second transfer structure Q2 in the non-display area BB, and a fourth common wiring H in the display area AA. The third common wiring D is electrically connected to the fourth common wiring H through the second transfer structure Q2.

In some embodiments, referring to FIG. 6, the display substrate further includes: an electrostatic release ring G1, a first electrostatic release circuit G2, and a second electrostatic release circuit G3. The common electrode C is electrically connected to the electrostatic release ring G1 through the first electrostatic release circuit G2. The fanout wiring F0 (for example, the first sub-fanout wiring F11) is electrically connected to the electrostatic release ring G1 through the second electrostatic release circuit G3 to release the generated static electricity.

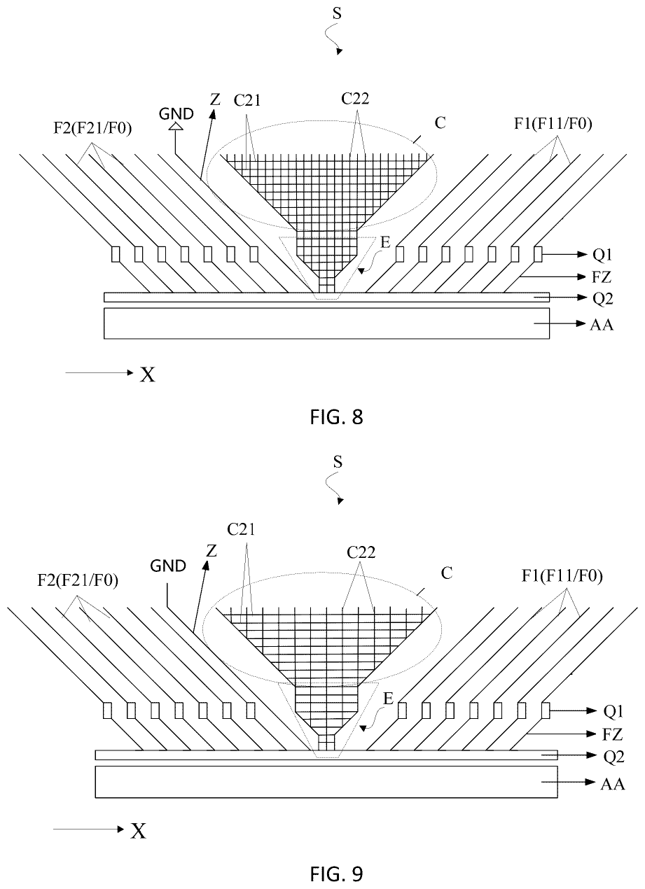

In some embodiments, as shown in FIG. 8, the plurality of first common wirings C21 may also extend along the first direction X. The plurality of second common wirings C22 may also extend along a direction perpendicular to the first direction X, that is, extend longitudinally. The plurality of first common wirings C21 and the plurality of second common wirings C22 intersect to form a grid structure. In some embodiments, as shown in FIG. 8, at least one dummy wiring Z is disposed between the common electrode C and the fanout wiring group F. The extension direction of the dummy wiring Z is the same as the extension direction of the adjacent fanout wiring F0.

In some embodiments, as shown in FIG. 9, the plurality of first common wirings C21 may also extend along the first direction X. The plurality of second common wirings C22 may also extend along a direction perpendicular to the first direction X, that is, extend longitudinally. The plurality of first common wirings C21 and the plurality of second common wirings C22 intersect to form a grid structure. In some embodiments, as shown in FIG. 8, at least one dummy wiring Z is disposed between the common electrode C and the fanout wiring group F. The extension direction of the dummy wiring Z is the same as the extension direction of the adjacent fanout wiring F0. Different from the embodiments shown in FIG. 8, the embodiments shown in FIG. 9 increase the area of the grid in the common electrode C, and increase the aperture ratio from less than 50% to greater than 50%. The area of the grid becomes larger, and the orientation liquid flows more easily.

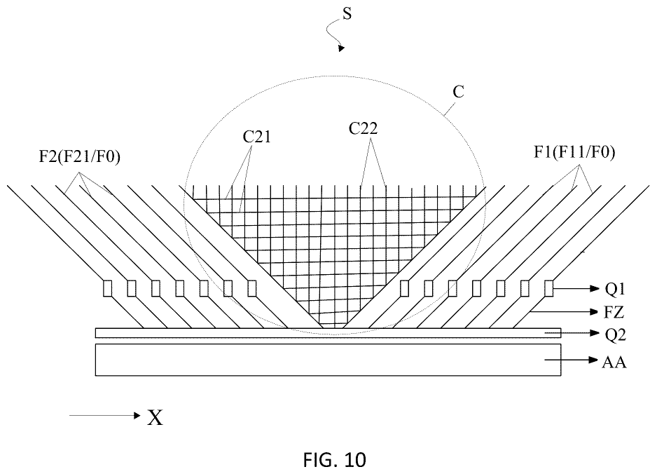

In some embodiments, as shown in FIG. 10, the plurality of first common wirings C21 may also extend along the first direction X. The plurality of second common wirings C22 may also extend along a direction perpendicular to the first direction X, that is, extend longitudinally. The plurality of first common wirings C21 and the plurality of second common wirings C22 intersect to form a grid structure. Different from the embodiments shown in FIG. 8, the embodiments shown in FIG. 10 increase the area of the grid in the common electrode C (from an aperture ratio of less than 50% to greater than 50%), while not setting a connecting electrode. That is, the overall shape design of the common electrode C is changed. The overall shape is changed from the original irregular polygon to a triangle, thereby increasing the overall wiring area of the common electrode C and reducing the area of the channel formed in the blank region between the Fanout region and the Vcom region, making it easier for the orientation liquid to flow.

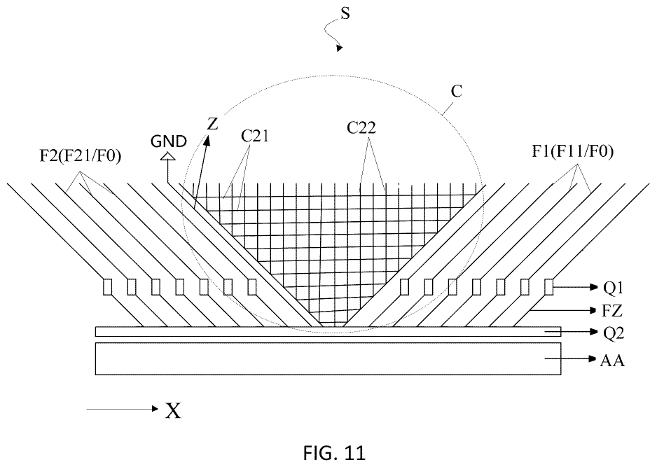

In some embodiments, as shown in FIG. 11, the plurality of first common wirings C21 may also extend along the first direction X. The plurality of second common wirings C22 may also extend along a direction perpendicular to the first direction X, that is, extend longitudinally. The plurality of first common wirings C21 and the plurality of second common wirings C22 intersect to form a grid structure. The embodiments shown in FIG. 11 change the overall shape design of the common electrode C from the original irregular polygon to a triangle, thereby increasing the overall wiring area of the common electrode C. Different from the embodiments shown in FIG. 10, in the embodiments shown in FIG. 11, at least one dummy wiring Z is arranged between the common electrode C and the fanout wiring group F. The extension direction of the dummy wiring Z is the same as the extension direction of the adjacent fanout wiring F0.

Based on the same inventive concept, embodiments of the present disclosure further provide a display panel, which includes a display substrate provided by the embodiments of the present disclosure.

The array substrate provided by the embodiments of the present disclosure may include a pixel circuit. A plurality of transistors in the pixel circuit may be low-temperature polysilicon thin film transistors, or may be oxide thin film transistors, or may be low-temperature polysilicon thin film transistors and oxide thin film transistors. The active layer of the low temperature polysilicon thin film transistor uses low temperature polysilicon (LTPS), and the active layer of the oxide thin film transistor uses oxide. Low-temperature polysilicon thin-film transistors have the advantages of high mobility and fast charging, while oxide thin-film transistors have the advantages of low leakage current. In some examples, low-temperature polysilicon thin-film transistors and oxide thin-film transistors can be integrated on a display panel to form a low-temperature polycrystalline oxide display panel, which can take advantage of the advantages of both to achieve high resolution (PPI, Pixel Per Inch), low-frequency driving, reduce power consumption, and improve display quality. However, the embodiments are not limited to this.

The array substrate provided in the embodiments of the present disclosure is suitable for both vertical alignment (VA) type liquid crystal display screens and advanced dimension switch (ADS) type liquid crystal display screens.

Based on the same inventive concept, embodiments of the present disclosure further provide a display apparatus, which includes the display panel provided by the embodiments of the present disclosure.

In implementations, in embodiments of the present disclosure, the display apparatus may be: a mobile phone, a tablet computer, a television, a monitor, a laptop computer, a digital photo frame, a navigator, or any other product or component with a display function. Other essential components of the display apparatus should be understood by those skilled in the art and will not be described in detail herein and should not be construed as limiting the present disclosure.

Although preferred embodiments of the present disclosure have been described, additional changes and modifications may be made to these embodiments once those skilled in the art are aware of the basic inventive concepts. Therefore, it is intended that the appended claims be interpreted as including the preferred embodiment as well as all changes and modifications that fall within the scope of the present disclosure.

Obviously, those skilled in the art can make various changes and modifications to the present disclosure without departing from the spirit and scope of the present disclosure. Thus, if these modifications and variations of the present disclosure fall within the scope of the claims of the present disclosure and their equivalent technologies, the present disclosure is also intended to include these modifications and variations.

1. A display substrate provided with a display area and a non-display area at a periphery of the display area, wherein the display substrate comprises:
a plurality of fanout wiring groups in the non-display area; wherein at least one of the plurality of fanout wiring groups comprises: a plurality of fanout wirings;
a common electrode between adjacent fanout wiring groups in the non-display area; wherein the common electrode comprises:
a boundary wiring, and
a common wiring group in an region surrounded by the boundary wiring;
wherein the common wiring group comprises:
a plurality of first common wirings, and
a plurality of second common wirings,
wherein the plurality of first common wirings and the plurality of second common wirings intersect to form a grid structure;
wherein an extension direction of at least one of the plurality of first common wirings is the same as an extension direction of at least one of the plurality of fanout wirings.

2. The display substrate according to claim 1, wherein the plurality of first common wirings comprises:
a first sub-common wiring group and a second sub-common wiring group sequentially distributed along a first direction;
wherein the first sub-common wiring group comprises:
a plurality of first sub-common wirings extending along a same direction;
the second sub-common wiring group comprises:
a plurality of second sub-common wirings extending along a same direction;
wherein an extension direction of the first sub-common wiring is the same as an extension direction of the fanout wiring adjacent to the first sub-common wiring; and an extension direction of the second sub-common wiring is the same as an extension direction of the fanout wiring adjacent to the second sub-common wiring.

3. The display substrate according to claim 2, wherein the fanout wiring group comprises:
a first sub-fanout wiring group and a second sub-fanout wiring group sequentially distributed along the first direction;
wherein the first sub-fanout wiring group comprises:
a plurality of first sub-fanout wirings extending along a same direction;
the second sub-fanout wiring group comprises:
a plurality of second sub-fanout wirings extending along a same direction;
wherein an extension direction of the second sub-fanout wiring is different from an extension direction of the first sub-fanout wiring;
the first sub-common wiring group is adjacent to the second sub-fanout wiring group in one of the fanout wiring groups, and the extension direction of the first sub-common wiring is the same as an extension direction of the second sub-fanout wiring adjacent to the first sub-common wiring; the second sub-common wiring group is adjacent to the first sub-fanout wiring group in another one of the fanout wiring groups, and the extension direction of the second sub-common wiring is the same as an extension direction of the first sub-fanout wiring adjacent to the second sub-common wiring.

4. The display substrate according to claim 2, wherein the second common wiring extends in a direction perpendicular to the first direction.

5. The display substrate according to claim 2, wherein the second common wiring comprises:
a plurality of third sub-common wirings extending in a same direction, and
a plurality of fourth sub-common wirings extending in a same direction;
wherein an extension direction of the third sub-common wiring is perpendicular to the extension direction of the first sub-common wiring, and the third sub-common wirings and the first sub-common wirings intersect to form a grid structure;
an extension direction of the fourth sub-common wiring is perpendicular to the extension direction of the second sub-common wiring, and the fourth sub-common wirings and the second sub-common wirings intersect to form a grid structure.

6. The display substrate according to claim 5, wherein:
a first gap is formed between one first sub-common wiring and another first sub-common wiring adjacent to a side of the one first sub-common wiring, and a second gap is formed between the one first sub-common wiring and another first sub-common wiring adjacent to another side of the one first sub-common wiring; and the third sub-common wirings in the first gap and the second gap are staggered;
a third gap is formed between one second sub-common wiring and another second sub-common wiring adjacent to a side of the one second sub-common wiring, and a fourth gap is formed between the one second sub-common wiring and another second sub-common wiring adjacent to another side of the one second sub-common wiring; the fourth sub-common wirings in the third gap and the fourth gap are staggered.

7. The display substrate according to claim 1, further comprising:
a third common wiring located in the non-display area and on a side of the common electrode facing the display area;
a connecting electrode connecting the third common wiring and the common electrode;
wherein the connecting electrode comprises:
a plurality of first connecting wirings, and
a plurality of second connecting wirings;
wherein the first connecting wirings and the second connecting wirings intersect to form a grid structure.

8. The display substrate according to claim 7, wherein the first connecting wiring comprises:
a first sub-connecting wiring, and
a second sub-connecting wiring;
wherein an extension direction of the first sub-connecting wiring is the same as the extension direction of the first sub-common wiring; an extension direction of the second sub-connecting wiring is the same as the extension direction of the second sub-common wiring.

9. The display substrate according to claim 7, wherein the first connecting wiring extends along a first direction, and the second connecting wiring extends in a direction perpendicular to the first direction.

10. (canceled)

11. The display substrate according to claim 7, wherein the common electrode comprises:
a plurality of first grids,
a plurality of second grids, and
a plurality of third grids;
wherein an area of the first grid is greater than an area of the second grid, and the area of the second grid is greater than an area of the third grid.

12. The display substrate according to claim 11, wherein the common electrode comprises:
a first common electrode region, a second common electrode region, and a third common electrode region sequentially distributed along a first direction;
wherein the second grids are distributed in the first common electrode region and the third common electrode region;
the first grids and the third grids are distributed in the second common electrode region, and in a direction perpendicular to the first direction, the first grids and the third grids are alternately distributed.

13. The display substrate according to claim 11, wherein:
an area of a grid in the connecting electrode is substantially equal to the area of the second grid in the common electrode; or
an area of a grid in the connecting electrode is larger than an area of the first grid in the common electrode.

14. (canceled)

15. The display substrate according to claim 7, wherein an aperture ratio of the connecting electrode is greater than 50%; and an aperture ratio of the common electrode is greater than 50%.

16. The display substrate according to claim 1, further comprising:
a third common wiring located in the non-display area and on a side of the common electrode facing the display area;
wherein the common electrode is directly electrically connected to the third common wiring.

17. The display substrate according to claim 1, wherein at least one dummy wiring is provided between the common electrode and the fanout wiring group; and an extension direction of the dummy wiring is the same as an extension direction of the fanout wiring adjacent to the dummy wiring.

18. The display substrate according to claim 17, wherein a plurality of dummy wirings are evenly distributed between the common electrode and the fanout wiring group.

19. The display substrate according to claim 1, further comprising in the non-display area:
a plurality of first transfer structures, and
fanout region transfer wirings corresponding one to one with the fanout wirings;
wherein the fanout region transfer wirings are electrically connected to the fanout wirings through the first transfer structures.

20. The display substrate according to claim 7 or 16, further comprising:
a second switching structure in the non-display area;
wherein the third common wiring is electrically connected to a fourth common wiring in the display area through the second switching structure.

21. A display panel, comprising the display substrate according to claim 1.

22. A display apparatus, comprising the display panel according to claim 21.
